(19) United States
(12) Patent Application Publication
(10) Pub. No.: US 2015/0256963 A1
(43) Pub. Date: Sep. 10, 2015

(54) LIGHTING SYSTEMS WITH SHORT RANGE COMMUNICATION CAPABILITIES

(71) Applicant: KENALL MANUFACTURING COMPANY, Gurnee, IL (US)

(72) Inventor: Kevin Dahlen, Lindenhurst, IL (US)

(73) Assignee: KENALL MANUFACTURING COMPANY, Gurnee, IL (US)

(21) Appl. No.: 14/199,017

(22) Filed: Mar. 6, 2014

(51) Int. Cl. H04W 4/00

(52) U.S. Cl. CPC H04W 4/008

(57) ABSTRACT

Embodiments are provided for configuring luminaires with transmitters that are capable of broadcasting signals via various short range communication protocols. According to aspects, the signals may uniquely identify the luminaires and may also be detectable by various electronic devices. Upon detecting a signal, an electronic device may identify the luminaire and retrieve data associated with the location of the luminaire. The electronic device may further enable various location-based features and services that improve a user's experience with the electronic device and the associated environment. By leveraging a lighting system setup for the transmitter network, costs associated with installing and modifying the transmitter are reduced.

### FIELD

This application generally relates to lighting systems. In particular, the application relates to platforms and techniques for leveraging luminaires installed in lighting systems to facilitate short range communication and transmission functionalities.

### BACKGROUND

Most commercial buildings, parking structures, transportation areas or structures, and the like are equipped with lighting systems that typically include several luminaires or light fixtures. The luminaires are usually installed on or secured to specific locations of the structures. Because lighting systems are designed to last several years, the luminaires will often remain in the same place for long periods of time before there is a need to rearrange or replace the luminaires.

In another regard, mobile device usage by users is becoming increasingly prevalent. As mobile device usage by individuals continues to increase, more applications that leverage the computing power of the mobile devices will start to emerge. As an example, some applications use location data, such as data detected via a global positioning system (GPS) chip, to enable various location-based features. To support certain location-based features, businesses located in certain structures or buildings must install numerous hardware components and modules throughout the structures or buildings. This can prove costly and time consuming for the businesses. Further, layouts and floor plans often change frequency, which adds to costs of uninstalling and reinstalling the hardware components and modules.

Accordingly, there is an opportunity to leverage components that are existing or that are infrequently modified, to enable and support location-based features in applications.

### SUMMARY

In an embodiment, a luminaire for transmitting signals to electronic devices is provided. The luminaire includes a housing adapted to securely mount to a structure, a light source disposed in the housing, the light source for generating light, and a transmitter disposed on the luminaire and configured to broadcast a signal that is detectable by at least one electronic device, wherein the signal identifies the luminaire.

In another embodiment, a lighting system installed in a structure is provided. The lighting system includes a first luminaire configured to generate light, and a first transmitter secured to the first luminaire and configured to broadcast a first signal that is detectable by at least one electronic device, wherein the first signal uniquely identifies the first luminaire. The lighting system further includes a second luminaire positioned in proximity to the first luminaire and configured to generate additional light, and a second transmitter secured to the second luminaire and configured to broadcast a second signal that is detectable by the at least one electronic device, wherein the second signal uniquely identifies the second luminaire.

In a further embodiment, a method of installing a luminaire with signal transmission capabilities is provided. The method includes mounting the luminaire on a structure, the luminaire comprising a light source for generating light, and securing a transmitter to a portion of the luminaire. The method further includes connecting the luminaire to a power source that enables the light source to provide light in a vicinity of the luminaire, and configuring the transmitter to broadcast, via a short range communication protocol, a signal that identifies the luminaire.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 depicts an example luminaire utilized in existing lighting systems, in accordance with some embodiments.

FIG. 2 depicts an example layout of an existing lighting system including a plurality of luminaires, in accordance with some embodiments.

FIG. 3 depicts an example luminaire configured with signal transmission capabilities, in accordance with some embodiments.

FIG. 4 depicts an example layout of a lighting system including a plurality of luminaires, in accordance with some embodiments.

FIGS. 5A and 5B depict example interfaces associated with a location-based application, in accordance with some embodiments.

FIG. 6 depicts an example layout of a lighting system including a plurality of luminaires, in accordance with some embodiments.

FIGS. 7A and 7B depict example interfaces associated with a location-based application, in accordance with some embodiments.

FIG. 8 depicts a flow chart associated with installing luminaires with signal transmission capabilities, in accordance with some embodiments.

### DETAILED DESCRIPTION

The novel methods and systems disclosed herein generally relate to lighting systems including a plurality of luminaires configured with signal transmission capabilities. Each of the luminaires is equipped with a transmitter module that is configured for short-range communication capabilities. In particular, each transmitter module may broadcast a signal that uniquely identifies the luminaire associated with the transmitter module. An electronic device that is within broadcast range of the transmitter may detect the signal and examine the signal to identify the luminaire. An application that is installed on the electronic device can use the luminaire identification to identify a location of the luminaire and retrieve relevant location-based information based on the luminaire location. In particular, the application may be programmed with certain location data that is helpful or useful in various buildings, structures, or environments. For example, the application can use the location information to enable a user to navigate through a parking garage. For further example, the application can use the location information to improve a user's shopping experience within a store.

Administrators or technicians of existing signal transmission have to install numerous modules or “beacons” in numerous locations of a space. These modules are often not hidden from view of users or customers, which can be undesirable in such environments as stores or businesses. Further, programmers experience difficulty programming layouts and location data associated with the modules because, among other reasons, it is difficult to assess the actual location of the modules once they are installed. Moreover, if a layout of a space (e.g., a department store) changes, then the modules need to be uninstalled from their existing locations and installed in new locations.

The systems and methods as discussed herein offer numerous advantages over existing location-based application installations. By affixing or securing transmitters to luminaires of lighting systems, administrators or technicians need not relocate the transmitters if a layout of the space or environment changes. Further, the transmitters may be more easily hidden from view of users or customers. Moreover, the locations of the luminaires are easily identified from blueprints and floor plans. Therefore, the locations of the transmitters are accurately assessed, which improves a programmer's ability to develop location-based services and features for associated applications. It should be appreciated that additional advantages and benefits are envisioned.

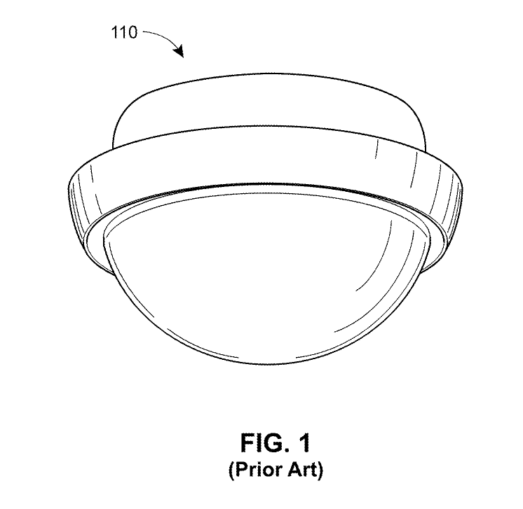

FIG. 1 is an example luminaire 110 that is used or installed in existing lighting systems. For example, a lighting system that includes a plurality of the luminaires 110 may be installed in a parking garage (or a floor or section of the parking garage), commercial building (or a portion thereof), roadway or other transportation structure (or a portion thereof), residential home or building, or other indoor or outdoor space or environment. As understood in the art, the luminaire 110 includes a light source that, when powered, illuminates an area proximate to or in a vicinity of the luminaire 110.

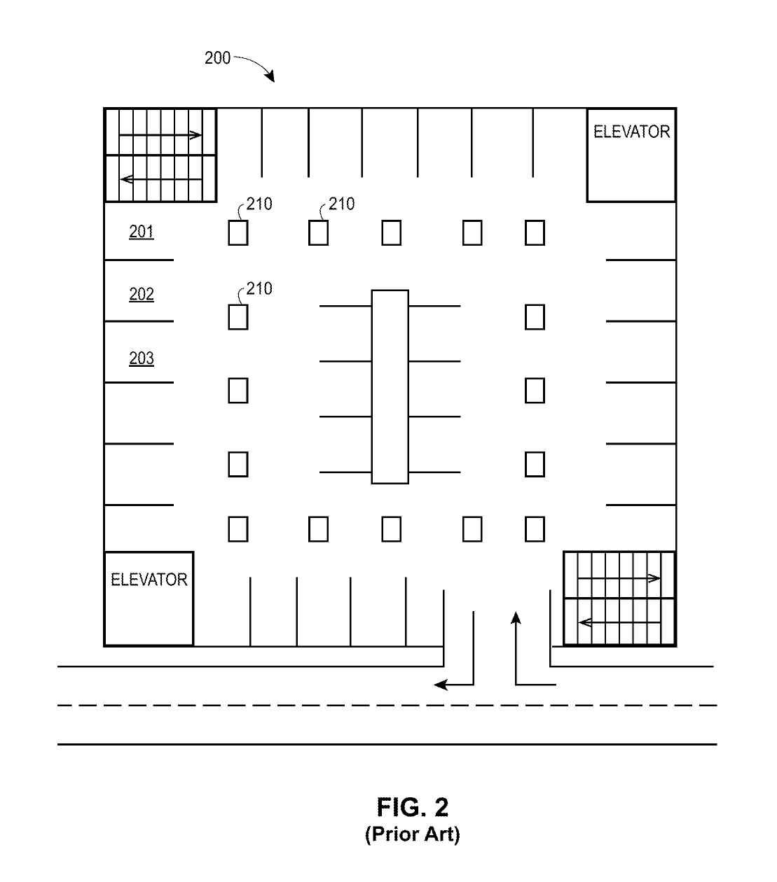

FIG. 2 illustrates a layout of an example parking garage 200 having an existing lighting system. In particular, the parking garage 200 includes a plurality of installed luminaires 210 and multiple parking spots 201, 202, 203. Generally, the plurality of luminaires 210 provide light that enables vehicles to locate parking spots and navigate the parking garage 200, among other uses and benefits. Further, the light from the plurality of luminaires 210 enable drivers to locate their vehicles when the drivers are ready to leave the parking garage 200.

With the proliferation of smart phones and other electronic devices, users are becoming more dependent on their electronic devices for various information, services, and features. For example, users often use electronic devices for navigation. As a result, users are generally spending more time interfacing with the electronic devices. The existence of the plurality of luminaires 210 is an opportunity to implement systems and methods that support or make possible various services and features, such as location-aware services and features. However, in existing lighting systems such as the lighting system illustrated in FIG. 2, the plurality of luminaires 210 are not leveraged at all to enable these services and features.

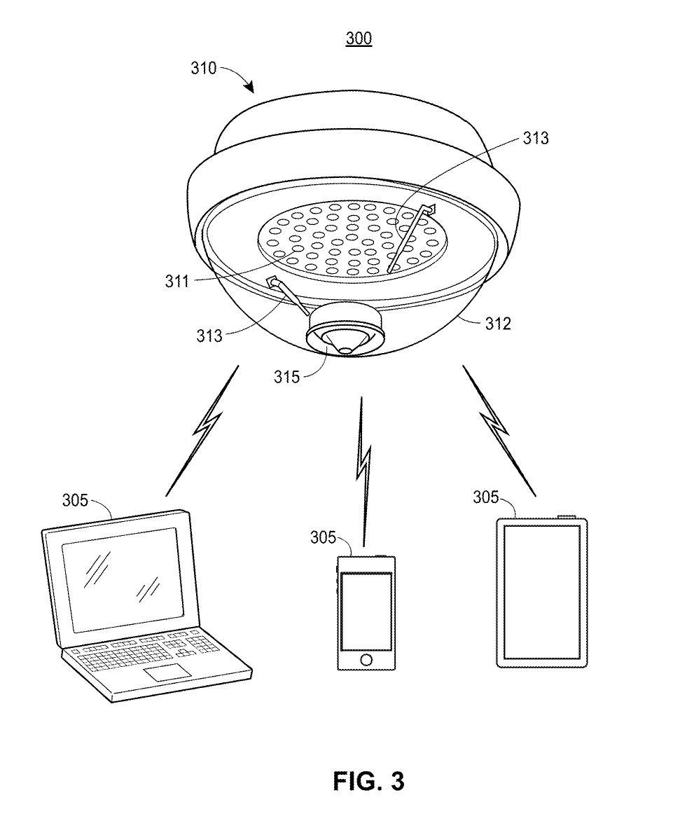

FIG. 3 is an example representation of an environment 300 and components thereof for enabling communication between luminaires and electronic devices, according to present embodiments. As shown in FIG. 3, the environment 300 includes a plurality of electronic devices 305 and an example luminaire 310. Each of the electronic devices 305 may be, for example, a handheld wireless device, a mobile phone, a Personal Digital Assistant (PDA), a smart phone, a tablet or laptop computer, a multimedia player, an MP3 player, a digital broadcast receiver, a remote controller, or any other electronic apparatus that is configured to detect or receive signals. The luminaire 310 may be any type of light fixture, light fitting, or other device used to create light by use of an electric lamp, and may include a fixture body and a light socket to hold the lamp and allow for a replacement lamp. As illustrated in FIG. 3, the luminaire 310 can include an array 311 of LEDs, however it should be appreciated that any other type of light source is envisioned (e.g., incandescent bulbs, fluorescent lamps, etc.). The luminaire 310 may further be adapted to mount or secure to a building, location, or structure so as to provide light in an associated area of the building, location, or structure.

According to embodiments, the luminaire 310 may be included as one of a plurality of luminaires. It should be appreciated that the plurality of luminaires need not be uniform (i.e., the plurality of luminaires can be of different types, sizes, model numbers, etc.). According to some embodiments, the plurality of luminaires can collectively be associated with a lighting system or a portion thereof. For example, the lighting system can be included in a parking garage (or a floor or section of the parking garage), commercial building (or a portion thereof), roadway or other transportation structure (or a portion thereof), residential home or building, or other indoor or outdoor space or environment. It should be appreciated that the plurality of luminaires may be powered by an electric circuit and may also connect to each other via a wired or wireless connection (such as to form a mesh network). Further, it should be appreciated that the plurality of luminaires may connect to and, once commissioned, be controlled by a central controller or similar device or component.

According to embodiments, the luminaire 310 includes a transmitter 315 affixed or secured thereto, or otherwise disposed thereon. FIG. 3 depicts the transmitter 315 as secured to a lens 312 of the luminaire 310. It should be appreciated that the transmitter 315 may be secured to any portion of the luminaire 310 according to any technique (e.g., screws, adhesive, wires, or other type of fastener). For example, the transmitter 315 may be affixed adjacent to the array 311 of LEDs using a set of screws. The transmitter 315 may communicate via one or more optional antennas 313 that may also be secured to the luminaire 310. In particular, the antennas 313 may send signals to the transmitter 315, which is configured to forward or broadcast the signals. The transmitter 315 may also broadcast signals without use of the antennas 313.

The transmitter 315 may be positioned such that it is obscured from view or visible. For example, the transmitter 315 may be positioned on the lens 312, as shown in FIG. 3. For further example, the transmitter 315 may be positioned underneath the lens 312 and adjacent to the array 311 of LEDs. The transmitter 315 may include any combination of hardware and software, including a module for transmitting or broadcasting signals. Further, the transmitter 315 may be configured to be powered by a battery or via another power source. For example, the transmitter 315 may be powered by the same electric circuit that powers the luminaire 310 and/or any additional luminaires.

According to embodiments, the transmitter 315 may store or access various data, such as a unique identifier associated with the luminaire 310. In some embodiments, the unique identifier may be composed of a universally unique identifier (UUID), a major value, and a minor value. In particular, in lighting systems that include multiple luminaires each having a transmitter 315 (e.g., a plurality of luminaires in a parking garage), each of the transmitters 315 can have the same UUID. Further, each of the transmitters can have different major values and/or minor values such that the transmitters may be uniquely identified. In other embodiments, each of the transmitters 315 in a lighting system may have a different UUID without including a major value and/or a minor value.

It should be appreciated that other identifying systems and conventions may be employed to uniquely identify luminaires that are included in a lighting system. In some embodiments, the luminaire 310 may also include one or more sensors such as, for example, a thermometer, a humidity sensor, a pressure sensor, an accelerometer, a gyroscope, and/or a magnetometer. The luminaire 310 (or the transmitter 315) may therefore be configured to store the corresponding sensor data and the transmitter 315 may be configured to communicate the corresponding sensor data.

According to embodiments, the transmitter 315 may support one or more short-range communication protocols such as radio-frequency identification (RFID), Bluetooth®, Bluetooth® low energy (BLE), Infrared Data Association (IrDA), near field communication (NFC), ZigBee, other protocols defined under the IEEE 802 standard, and/or other technologies. The transmitter 315 may also be configured to broadcast or transmit any stored data (e.g., its unique identifier). In particular, the transmitter 315 may enter a “broadcast mode” whereby the transmitter 315 continuously broadcasts a signal that includes the unique identifier of the corresponding luminaire 310 (or the transmitter 315 itself).

The signal that the transmitter 315 broadcasts may have an associated detection range, depending on the type of communication protocol. Generally, Bluetooth® signals have a range of 100 meters and BLE signals have a range of 50 meters. The detection range of the signal that the transmitter 315 broadcasts may also vary and may be programmable. For example, the range of a first signal that is broadcast by a first transmitter 315 may be fifteen (15) meters while the range of a second signal that is broadcast by a second transmitter 315 may be twenty-five (25) meters. When one of the electronic devices 305 is within broadcast range of the transmitter 315, the electronic device 305 can detect and receive the signal. In particular, a communication module of the electronic device 305 that supports short range communication protocol (e.g., a BLE chip) can detect and receive the signal.

According to embodiments, each of the electronic devices 305 may be configured to support one or more applications that are configured to process signal data received from transmitters. The applications may be offered by various companies, entities, stores, or the like, and may be downloadable by users of the electronic devices 305. The application(s) installed on the electronic devices 305 may examine, process, or analyze the signal and initiate any related services or features. The application(s) can examine the received signal and identify the unique identifier (e.g., UUID, minor value, and major value) corresponding to the luminaire 310. The application(s) can also identify or determine an accuracy value, a proximity value, a received signal strength indication (RSSI), and/or other data. The application(s) can examine the accuracy, the proximity value, and/or the RSSI to determine a distance from the corresponding electronic device 305 to the transmitter 315 (and therefore the luminaire 310) that broadcasted the signal. In particular, the accuracy can represent a degree of interference between the transmitter 315 and the electronic device 305, the proximity can indicate a relative distance between the transmitter 315 and the electronic device 305 (e.g., far, immediate, near, etc.), and the RSSI is a numeric value for the power present in the received signal (i.e., the signal strength).

The application of the electronic device 305 can also store an association between the unique identifier of the transmitter 315 and other data. In some cases, the application can associate the unique identifier with a location on a layout map. When there are multiple transmitters associated with multiple luminaires, the application can associate multiple unique identifiers with multiple locations of the luminaires on a layout map. In embodiments, the application can retrieve or access (e.g., via a network such as the Internet) the associated data using the unique identifier identified from the signal that was broadcasted by the transmitter 315, such as in cases in which the electronic device 305 does not store the data locally.

In embodiments, the application may analyze data from multiple signals that are broadcasted by multiple transmitters 315, in a technique known as triangulation. For example, the electronic device 305 may receive three signals from three different transmitters 315: transmitter A, transmitter B, and transmitter C. The application on the electronic device 305 can examine the signals and identify the respective unique identifiers of transmitter A, transmitter B, and transmitter C. Further, the application can also identify the respective RSSI values (along with any accuracy and proximity measurements) for the corresponding signals and determine that transmitter A is 20 meters away, transmitter B is 5 meters away, and transmitter C is 10 meters away. By reconciling this proximity data with any layout data associated with the lighting system (and by extension the locations of the transmitters), the application is able to approximate the location of the electronic device 305 with a good amount of accuracy.

In various embodiments, the application can further associate unique identifiers of luminaires (and locations of associated luminaires) with other data that may also be useful to a user of the application. For example, for a lighting system in a parking garage, the application can communicate to a user the distance (and directions) between a user's current location and a location of the user's parked vehicle. For further example, for a lighting system in a department store, the application can communicate or display various items for sale that are in the vicinity of the electronic device. It should be appreciated that the application is configured to store or access any other type of data that can be associated with unique identifiers of transmitters secured to luminaires of a lighting system.

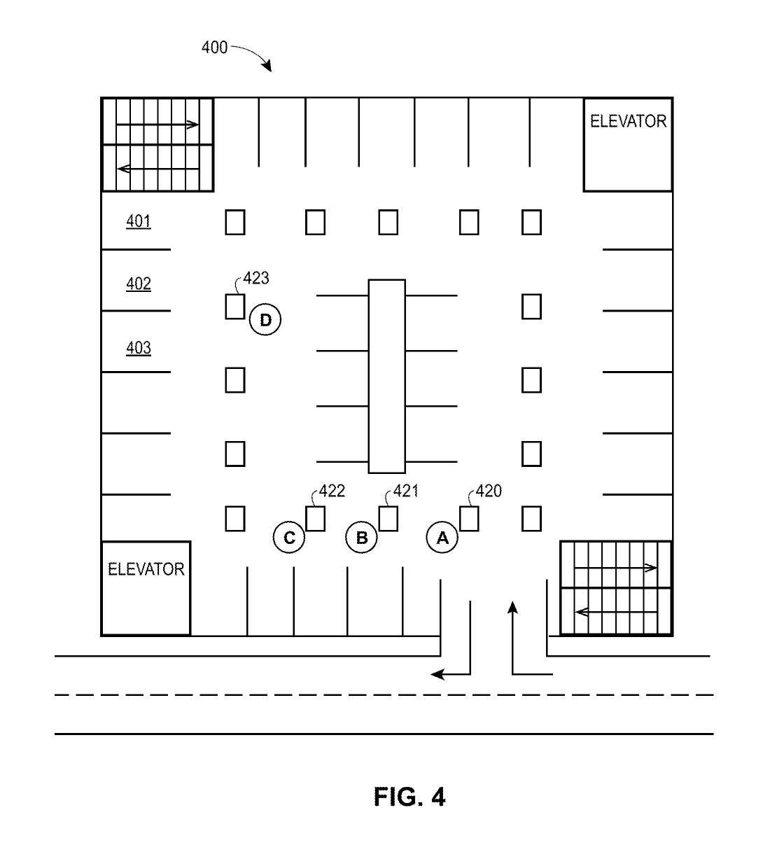

FIG. 4 depicts an example layout of a parking garage 400. In particular, the parking garage 400 includes a lighting system having a plurality of luminaires 420, 421, 422, 423 that each supports a short range communication transmitter (such as the transmitter 315 as discussed with respect to FIG. 3). The parking garage 400 also includes a plurality of parking spots 401, 402, 403 where drivers may park their vehicles. The drivers (i.e., users) may carry electronic devices that are configured to receive signals from the transmitters of the plurality of luminaires 420, 421, 422, 423, as discussed with respect to FIG. 3.

The transmitters may be configured to broadcast signals having various ranges. In some embodiments, the ranges may be greater than the distances between the luminaires 420, 421, 422, 423, so as to enable the electronic devices to receive multiple signals and calculate current locations using triangulation techniques. In other embodiments, the ranges may be equal or smaller than the distances between the luminaires 420, 421, 422, 423, such that the instances of electronic devices receiving multiple signals are reduced. The electronic devices may each support one or more applications that provide navigation features and/or other features or services for the users that leverage the transmitters of the plurality of luminaires 420, 421, 422, 423.

Numerous example operations associated with the parking garage 400 and the associated lighting system (as well as other environments) are envisioned. For example, in one operation, after a user parks his or her vehicle, the user can input where the vehicle is parked into an application associated with the parking garage 400 or with another entity (e.g., via the electronic device identifying its current location). When the user is returning to the vehicle, the application can navigate the user to where the vehicle is parked.

Referring to FIG. 4, if a user is positioned at location “A,” the electronic device of the user can receive a signal broadcasted by a transmitter secured to the luminaire 420 (and optionally signals from other luminaires that broadcast signals having ranges that extend to location “A”). The application of the electronic device can identify, from the signal, the unique identifier of the luminaire 420, and determine the location of the electronic device (and therefore the location of the user) based on the location associated with the unique identifier. In some embodiments, the application can examine multiple signals broadcast from multiple transmitters of multiple luminaires to determine or refine the location of the electronic device. Further, the application can display a user interface that includes the layout of the parking garage 400, the current location of the user, and the location of the parked vehicle. Further, the application can calculate and display navigation directions for the user to view as the user walks to the vehicle.

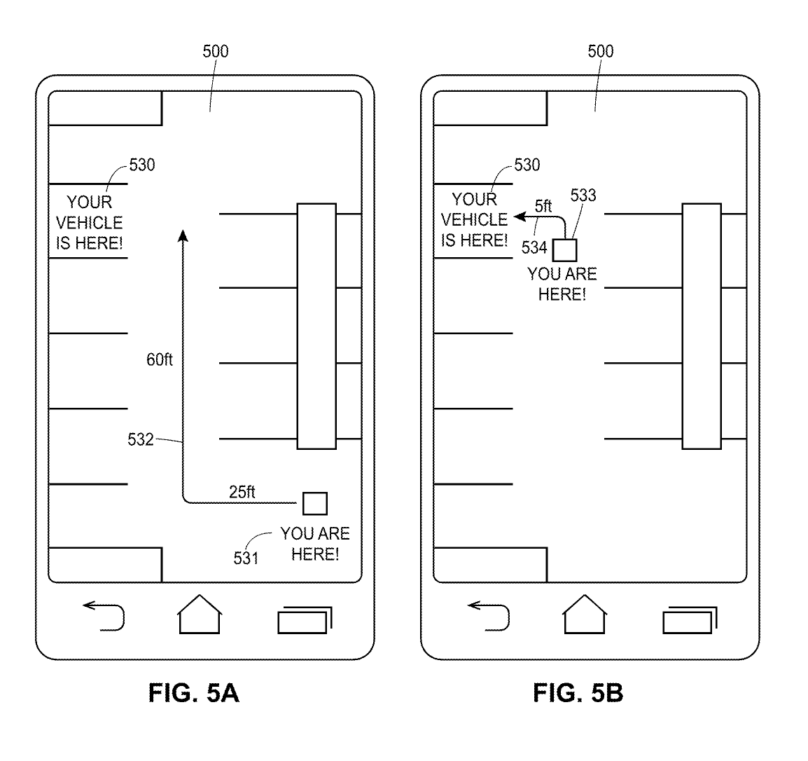

Referring to FIG. 5A, the application can generate an example interface 500 that displays a layout of a portion of the parking garage 400. The interface 500 can indicate a vehicle location 530 corresponding to where the user parked his or her vehicle. When the user is positioned at location “A” of the parking garage 400 (i.e., the electronic device receives at least a signal from the transmitter of the luminaire 420), the interface can indicate a current location 531 of the user that corresponds to location “A.” The application can further determine navigation directions 532 for the user based on the current location 531 and the vehicle location 530, and display the navigation directions 532 in the interface 500. In some embodiments, the navigation directions 532 can include turn-by-turn directions to the vehicle location 530.

As the user moves through the parking garage 400, the electronic device of the user can detect one or more signals from one or more other transmitters of the plurality of luminaires 420, 421, 422, 423. For example, if the user is positioned at location “B,” the electronic device can detect at least a signal from a transmitter secured to the luminaire 421, if the user is positioned at location “C,” the electronic device can detect at least signal from a transmitter secured to the luminaire 422, and if the user is positioned at location “D,” the electronic device can detect at least a signal from a transmitter secured to the luminaire 423. Of course, if the electronic device detects multiple signals from multiple of the luminaires, the electronic device can employ triangulation techniques to determine or refine its location.

Referring to FIG. 5B, the application can update the interface 500 that displays a layout of the portion of the parking garage 400 and navigation directions associated with the parking garage 400. In particular, the interface 500 of FIG. 5B can indicate the vehicle location 530 as well as an updated current location 533 (i.e., the electronic device receives at least a signal from the transmitter of the luminaire 423 as depicted in FIG. 4). The application can further display updated navigation directions 534 for the user based on the updated current location 533 and the vehicle location 530, and display the updated navigation directions 534 in the interface 500. Therefore, as the user walks to the vehicle, the application can dynamically update the interface 500 based on the various signals that the electronic device detects from one or more transmitters secured to one or more of the luminaires 420, 421, 422, 423.

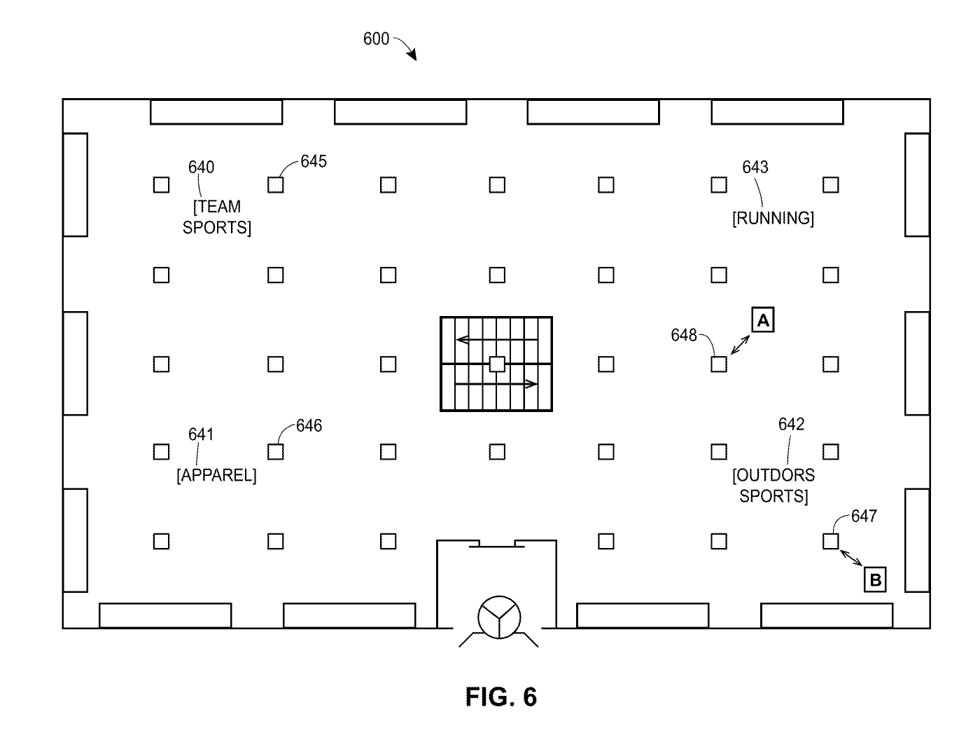

The functionalities discussed herein may also be implemented in other environments. For example, FIG. 6 depicts an example layout of a store 600 (as shown: a sporting goods store). The store 600 includes a lighting system having a plurality of luminaires 645, 646, 647, 648 that each supports a short range communication transmitter. The store 600 also includes a plurality of different departments (as shown: team sports 640, apparel 641, outdoor sports 642, and running 643) for shoppers to browse for associated products. The customers (or “users”) of the store 600 may carry electronic devices that are configured to receive signals from the transmitters of the plurality of luminaires 645, 646, 647, 648.

The electronic devices may each support an application that provides navigation features, shopping features, and/or other features or services for the users that leverage the transmitters of the plurality of luminaires 645, 646, 647, 648. According to embodiments, the application can display a layout map that indicates a user's current location as well as a layout of the store and its associated departments. Further, the application can identify and display products for sale that are in a vicinity of the user's location.

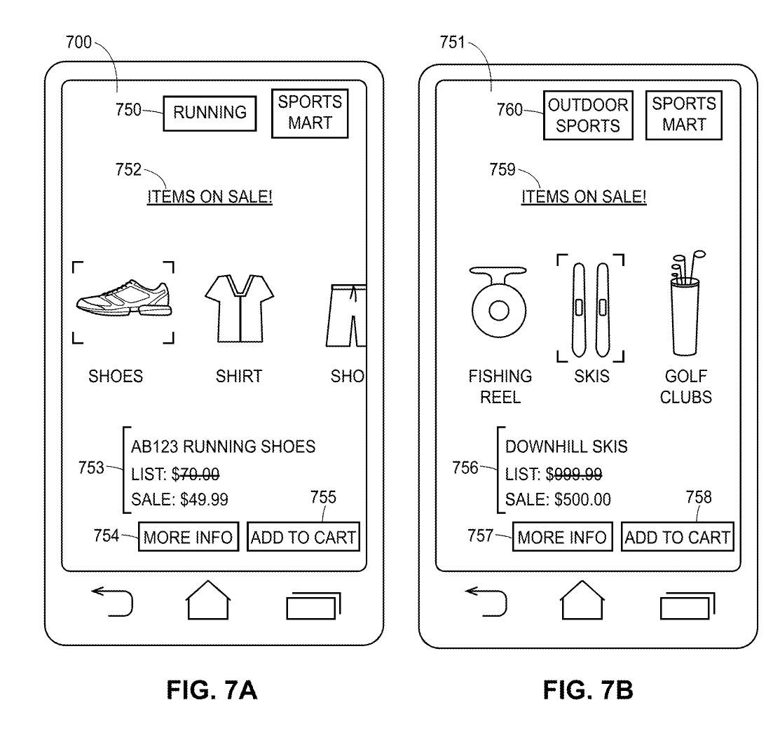

Referring to FIG. 7A, the application can display an example interface 700 that indicates a department 750 of the store 600 and displays items 752 that are for sale in the department 750. When the user is positioned at location “A” of the store 600 (i.e., the electronic device receives at least a signal from the transmitter of the luminaire 648), the application can determine that the user is located in or near the running department 643 of the store 600. Further, the application can identify various items that are for sale in the running department. As illustrated in FIG. 7A, the application displays, in the interface 700, the items 752 including shoes, a shirt, and shorts. The application can further display item information 753 for a highlighted or selected item (as shown: the shoes), as well as a selectable option 754 to display more information about the item (e.g., product description, reviews, etc.). The interface 700 can further include a selectable option 755 to add the item to a shopping cart and facilitate a check out procedure from the electronic device itself. It should be appreciated that other functionalities are envisioned.

As the user moves through the store 600, the electronic device of the user can detect signals from other transmitters of the plurality of luminaires 645, 646, 647, 648. For example, if the user is positioned at location “B,” the electronic device can detect a signal from a transmitter secured to the luminaire 647 (an optionally other transmitters that are secured to other nearby luminaires) and determine that the user is located in or near the outdoor sports department 642 of the store 600. Referring to FIG. 7B, the application can display an interface 751 to indicate the outdoor sports department 760 and display various items 759 that are for sale in the outdoor sports department (as shown: a fishing reel, skis, and golf clubs). The application can further display item information 756 for a highlighted or selected item (as shown: the skis), as well as a selectable option 757 to display more information about the item (e.g., product description, reviews, etc.). The interface 700 can further include a selectable option 758 to add the item to a shopping cart and facilitate a check out procedure from the electronic device itself. It should be appreciated that other functionalities are envisioned.

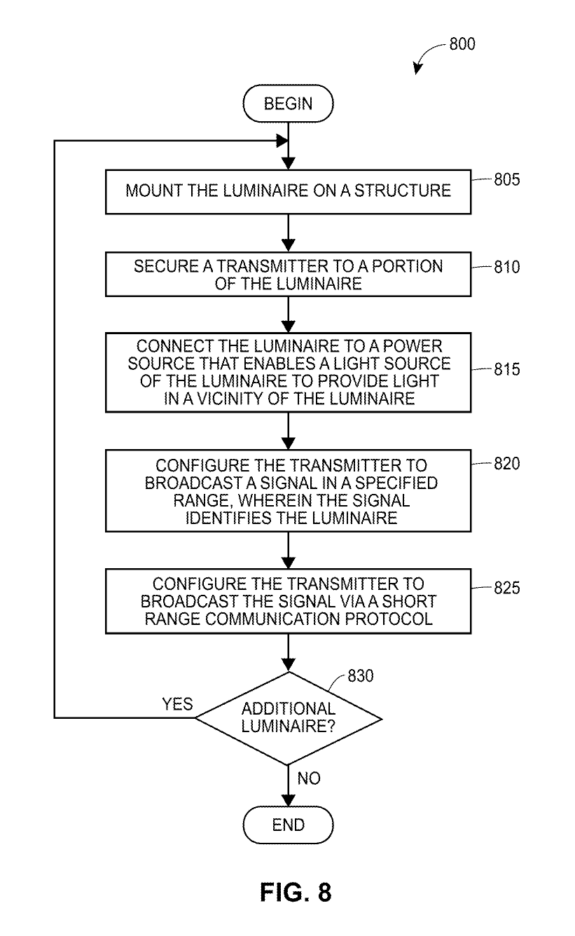

FIG. 8 is a flowchart of a method 800 for installing one or more luminaires with signal transmission capabilities. It should be appreciated that the method 800 may be performed by a person (e.g., a lighting technician, administrator, etc.) or by a machine or device. The method 800 begins by mounting (block 805) the luminaire on a structure. In embodiments, the structure may be any type of physical component within a building, environment, space, or the like. A transmitter is secured (block 810) to a portion of the luminaire, such as on a lens, under the lens, or positioned on any other part or portion of the luminaire.

The luminaire is connected (block 815) to a power source that enables a light source of the luminaire to provide light in a vicinity of the luminaire. The power source may be electrical power, battery power, or any other type of power source; and the light source may be LED, incandescent, fluorescent, or any other type of light source. The transmitter is configured (block 820) to broadcast a signal in a specified range, wherein the signal identifies the luminaire. In embodiments, the signal may be a UUID associated with the luminaire and the range may be configurable based on a variety of factors.

The transmitter is configured (block 825) to broadcast the signal via a short range communication protocol, such as RFID, Bluetooth®, BLE, IrDA, NFC, ZigBee, or other protocol. A determination is made (block 830) as to whether there is an additional luminaire to install, such as if the additional luminaire is part of the same lighting system. If there is not an additional luminaire (“NO”), the processing can end or proceed to any other functionality. If there is an additional luminaire (“YES”), processing can return to block 805 or to any other functionality.

Thus, it should be clear from the preceding disclosure that the systems and methods offer improved environments for enabling short range communication systems and configurations. The embodiments improve short range communication systems and configurations by effectively and efficiently leveraging luminaires that are already installed in structures and/or that are not frequently uninstalled or rearranged.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

1. A luminaire for transmitting signals to electronic devices, comprising:
a housing adapted to securely mount to a structure;
a light source disposed in the housing, the light source for generating light; and
a transmitter disposed on the luminaire and configured to broadcast a signal that is detectable by at least one electronic device, wherein the signal identifies the luminaire.

2. The luminaire of claim 1, wherein the transmitter broadcasts the signal via the Bluetooth low energy (BLE) communication protocol.

3. The luminaire of claim 1, further comprising a battery adapted to power the transmitter.

4. The luminaire of claim 1, wherein the transmitter broadcasts the signal in a detectable range of up to about fifty feet.

5. The luminaire of claim 4, wherein the detectable range is configurable.

6. The luminaire of claim 1, wherein the signal comprises a universally unique identifier (UUID) associated with the luminaire.

7. The luminaire of claim 1, wherein the signal is configured to, upon detection by the at least one electronic device, indicate at least one of an accuracy, a proximity and a received signal strength indication (RSSI).

8. The luminaire of claim 1, wherein the light source is selected from the group consisting of a light emitting diode (LED), an incandescent bulb, and a fluorescent lamp.

9. A lighting system installed in a structure, comprising:
a first luminaire configured to generate light;
a first transmitter secured to the first luminaire and configured to broadcast a first signal that is detectable by at least one electronic device, wherein the first signal uniquely identifies the first luminaire;
a second luminaire positioned in proximity to the first luminaire and configured to generate additional light; and
a second transmitter secured to the second luminaire and configured to broadcast a second signal that is detectable by the at least one electronic device, wherein the second signal uniquely identifies the second luminaire.

10. The lighting system of claim 9, wherein the second luminaire is positioned a distance apart from the first luminaire, and wherein:
the first transmitter broadcasts the first signal in a first detectable range that is equal to or less than the distance, and
the second transmitter broadcasts the second signal in a second detectable range that is equal to or less than the distance.

11. The lighting system of claim 9, wherein the second luminaire is positioned a distance apart from the first luminaire, and wherein:
the first transmitter broadcasts the first signal in a first detectable range that is greater than the distance, and
the second transmitter broadcasts the second signal in a second detectable range that is greater than the distance.

12. The lighting system of claim 9, wherein:
the first signal comprises a first universally unique identifier (UUID) associated with the first luminaire, and
the second signal comprises a second UUID associated with the second luminaire.

13. The lighting system of claim 9, wherein the first transmitter and the second transmitter respectively broadcast the first signal and the second signal via the Bluetooth low energy (BLE) communication protocol.

14. The lighting system of claim 9, wherein the first transmitter comprises a first battery adapted to power the first transmitter and the second transmitter comprises a second battery adapted to power the second transmitter.

15. A method of installing a luminaire with signal transmission capabilities, the method comprising:
mounting the luminaire on a structure, the luminaire comprising a light source for generating light;
securing a transmitter to a portion of the luminaire;
connecting the luminaire to a power source that enables the light source to provide light in a vicinity of the luminaire; and
configuring the transmitter to broadcast, via a short range communication protocol, a signal that identifies the luminaire.

16. The method of claim 15, wherein configuring the transmitter to broadcast the signal comprises:
configuring the transmitter to broadcast the signal via the Bluetooth low energy (BLE) communication protocol.

17. The method of claim 15, further comprising:
configuring the transmitter to broadcast the signal in a specified range.

18. The method of claim 15, wherein securing the transmitter to the portion of the luminaire comprises:
securing the transmitter to a lens of the luminaire.

19. The method of claim 15, wherein configuring the transmitter to broadcast the signal comprises:
configuring the transmitter to broadcast a universally unique identifier (UUID) associated with the luminaire.

20. The method of claim 15, further comprising:
mounting an additional luminaire on the structure, the additional luminaire comprising an additional light source for generating light;
securing an additional transmitter to a portion of the additional luminaire;
connecting the additional luminaire to the power source; and
configuring the additional transmitter to broadcast, via the short range communication protocol, an additional signal that identifies the additional luminaire.
